(19) United States
(12) Patent Application Publication
(10) Pub. No.: US 2011/0286614 A1
(43) Pub. Date: Nov. 24, 2011

(54) INDIVIDUALIZATION OF SOUND SIGNALS

(75) Inventor: Wolfgang Hess, Karlsbad (DE)

(73) Assignee: Harman Becker Automotive Systems GmbH, Karlsbad (DE)

(21) Appl. No.: 13/110,683

(22) Filed: May 18, 2011

(30) Foreign Application Priority Data
May 18, 2010 (EP) EP 10 005 186.1

(51) Int. Cl. H04R 5/02

(52) U.S. Cl. 381/302; 381/300

(57) ABSTRACT

A system and method provide a user-specific sound signal for each of multiple users in a room, such as a vehicle cabin, on a sound system including at least a pair of loudspeakers for each user. The head position of each user is tracked and a user-specific binaural sound signal is generated based on the tracked head position of at least one user. Crosstalk cancellation and cross-soundfield cancellation are performed on the user-specific binaural sound signal to enable a user-specific sound signal to be output on the respective loudspeaker pair for each user. In this way, different user-specific sound signals, which may include completely different audio programs, can be provided for each user in the room.

### RELATED APPLICATIONS

This application claims priority from European Patent Application Serial Number 10 005 186.1, filed on May 18, 2010, titled INDIVIDUALIZATION OF SOUND SIGNALS, the subject matter of which is incorporated in its entirety by reference in this application.

### BACKGROUND OF THE INVENTION

1. Field of the Invention

The present invention relates to a method for providing a user-specific sound signal for at least a first user of at least two users in a room, the sound signal for each of the at least two users being output by a respective pair of loudspeakers. The invention further relates to a system for providing a user-specific sound signal for at least a first user of at least two users. The invention especially, but not exclusively, relates to user-specific sound signals provided in a vehicle, where individual, seat-related sound signals for the different passengers in a vehicle cabin can be provided.

2. Related Art

In a vehicle environment, it is known to provide a common sound signal for all passengers in the vehicle. If the different passengers in the vehicle want to listen to different sound signals, the only existing possibility for individualizing the sound signals for the different passengers is the use of headphones. The individualization of sound signals output by a loudspeaker that is not part of a headphone has not heretofore been possible. Additionally, it is desirable to be able to provide a user-specific soundfield in other rooms besides vehicle cabins.

Accordingly, a need exists to provide the possibility to generate user-specific soundfields or sound signals for users in a room without the need to use headphones, but rather using loudspeakers provided in the room.

### SUMMARY OF THE INVENTION

A method for providing a user-specific soundfield for a first user of two users in a room is provided. A pair of loudspeakers is provided for each of the two users. The head position of the first user is tracked and a user-specific binaural sound signal for the first user is generated from a user-specific multi-channel sound signal for the first user based on the tracked head position of the first user. Additionally, a crosstalk cancellation for the first user is performed based on the tracked head position for the first user to generate a crosstalk cancelled user-specific sound signal. In the crosstalk cancellation the user-specific binaural sound signal is processed in such a way that the crosstalk cancelled user-specific sound signal, if it was output by one loudspeaker of the pair of loudspeakers of the first user for a first ear of the first user, is suppressed for the second ear of the first user. Additionally, the user-specific binaural sound signal is processed in such a way that the crosstalk cancelled user-specific sound signal, if it was output by the other loudspeaker of the pair of loudspeakers for a second ear of the first user, is suppressed for the first ear of the first user. Additionally, a cross-soundfield suppression is carried out in which the sound signals output for the second user by the pair of loudspeakers provided for the second user are suppressed for each ear of the first user based on the tracked head position of the first user.

According to the invention, based on a virtual multi-channel sound signal provided for the first user, a user-specific sound signal for that first user is generated. With the use of a user-specific binaural sound signal, a crosstalk cancellation and a cross-soundfield cancellation of the user-specific soundfield or sound signal can be obtained, allowing one user to follow the desired music signal, whereas the other user is not disturbed by the music signal output for the one user in the room via loudspeakers provided for the one user. A binaural sound signal is normally intended for replay using headphones. If a binaural recorded sound signal is reproduced by headphones, a listening experience can be obtained simulating the actual location of the sound where it was produced. If a normal stereo signal is played back with a headphone, the listener perceives the signal in the middle of the head. If, however, a binaural sound signal is reproduced by a headphone, the position from where the signal was originally recorded can be simulated.

In the present case, the output of the sound signal is not done using a headphone, but via a pair of loudspeakers provided for the first user in the room/vehicle. As the perceived sound signal depends on the head position of the listening user, the head position of the user is tracked and a crosstalk cancellation is carried out assuring that the sound signal emitted by one loudspeaker arrives at the intended ear, whereas the sound signal of this loudspeaker is suppressed for the other ear and vice versa. In addition, the cross-soundfield suppression helps to suppress the sound signals output for the second user by the pair of loudspeakers provided for the second user.

The method may be used in a vehicle where a user-/seat-related soundfield or sound signal can be generated. As the listener's position in a vehicle is relatively fixed, only small movements of the head in the translational and rotational direction can be expected. The head of the user can be captured using face tracking mechanisms as they are known for standard USB web cams. Using passive face-tracking, no sensor has to be worn by the user.

According to one example of an implementation of the invention, the user-specific binaural sound signal for the first user is generated based on a set of predetermined binaural room impulse responses (BRIR). The BRIR are determined for the first user for a set of possible different head positions of the first user in the room that were determined in the room using a dummy head. The user-specific binaural sound signal of the first user can then be generated by filtering the multi-channel user-specific sound signal with the BRIR of the tracked head position. In this example, a set of predetermined binaural room impulse responses of different head positions of the user in the room are determined using a dummy head and two microphones provided in the ears of the dummy. The set of predetermined binaural room impulse responses is measured in the room or vehicle in which the method is to be applied. This helps to determine the head-related transfer functions and the influences from the room on the signal path from the loudspeaker to the left or right ear. If one disregards the reflections induced by the room, it is possible to use the head-related transfer functions instead of the BRIR. The set of predetermined BRIR includes data for the different possible head positions. By way of example, the head position may be tracked by determining a translation in three different directions, e.g., in a vehicle backwards and forward, left and right, or up and down. Additionally, the three possible rotations of the head may be tracked. The set of predetermined binaural room impulse responses may then contain BRIRs for the different possible translations and rotations of the head. By capturing the head position, the corresponding BRIR can be selected and used for determining the binaural sound signal for the first user. In a vehicle environment it might be sufficient to consider two degrees of freedom for the translation (left/right and backwards/forward) and only one rotation, e.g. when the user turns the head to the left or right.

The user-specific binaural sound signal of the first user at the head position can be determined by determining a convolution of the user-specific multi-channel sound signal for the user with the binaural room impulse response determined for the head position. The multi-channel sound signal may be a 1.0, 2.0, 5.1, 7.1 or another multi-channel signal, the user-specific binaural sound signal is a two-channel signal, one for each loudspeaker corresponding to one signal channel for each ear of the user, equivalent to a headphone (virtual headphone).

For the crosstalk cancellation for the first user a head position dependent filter can be determined based on the tracked position of the head and based on the binaural room impulse response for the tracked position. The crosstalk cancellation can then be determined by determining a convolution of the user-specific binaural sound signal with the newly determined head position dependent filter. One possibility how the crosstalk cancellation using a head tracking is carried out is described by Tobias Lentz in “Dynamic Crosstalk Cancellation for Binaural Synthesis in Virtual Reality Environments” in J. Audio Eng. Soc., Vol. 54, No. 4, April 2006, pages 283-294, For a more detailed analysis how the crosstalk cancellation is carried out, reference is made to this article.

The sound signal of the second user is also a user-specific sound signal for which the head position of the second user is also tracked. The user-specific binaural sound signal for the second user is generated based on the user-specific multi-channel sound signal for the second user and based on the tracked head position of the second user. For the second user, a crosstalk cancellation is carried out based on the tracked head position of the second user, as mentioned above for the first user, and a cross-soundfield suppression is carried out in which the sound signals emitted for the first user by the loudspeakers for the first user are suppressed for the ears of the second user based on the tracked head position of the second user. Thus, for the crosstalk cancellation the crosstalk cancelled user-specific sound signal, if it was output by a first loudspeaker of the second user for the first ear, it is suppressed for the second ear of the second user. The crosstalk cancelled user-specific sound signal, if it was output by the other loudspeaker for the second user for the second ear, it is suppressed for the first ear of the second user.

The user-specific binaural sound signal for the second user is generated as for the first user by providing a set of predetermined binaural room impulse responses determined for the position of the second user for the different head positions in the room using the dummy head at the second position.

For the cross-soundfield cancellation, a suppression of the other soundfield for the other user of around 40 dB is enough in a vehicle environment, as the vehicle sound up to 70 dB covers the suppressed soundfield of the other user. The cross-soundfield suppression of the sound signals output for one of the users and suppressed for the other user may be determined using the tracked head position of the first user and the tracked head position of the second user and the binaural room impulse responses for the first user and the second user by using the head positions of the first and second user, respectively.

The invention further relates to a system for providing the user-specific sound signal including a pair of loudspeakers for each of the users and a camera tracking the head position of the first user. Furthermore, a database containing the set of predetermined binaural room impulse responses for the different possible head positions of the first user is provided. A processing unit is provided that is configured to process the user-specific multi-channel sound signal and to determine the user-specific binaural sound signal, to perform the crosstalk cancellation and the cross-soundfield cancellation, as described above. In case a user-specific soundfield is output for each of the users, the sound signal emitted for the second user depends on the head position of the second user. As a consequence, for carrying out the cross-soundfield cancellation of the first user, the head positions of the first and second user are necessary. As the individualized soundfields have to be determined for the different users and as each individual soundfield influences the determination of the other soundfield, the processing may be performed by a single processing unit receiving the tracked head positions of the two users.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of two users in a vehicle for which individual soundfields are generated.

FIG. 2 shows a schematic view of a user listening to a sound signal having the same listening impression as a listener using headphones and a binaural decoded audio signal, e.g., by convolution with 2.0 or 5.1 BRIRs.

FIG. 3 shows a schematic view of the soundfields of two users showing which soundfields are suppressed for which user of the two users.

FIG. 4 shows a more detailed view of the processing unit in which a multi-channel audio signal is processed in such a way that, when output via two loudspeakers, a user-specific sound signal is obtained.

FIG. 5 is a flowchart showing the different steps needed to generate the user-specific sound signals.

### DETAILED DESCRIPTION

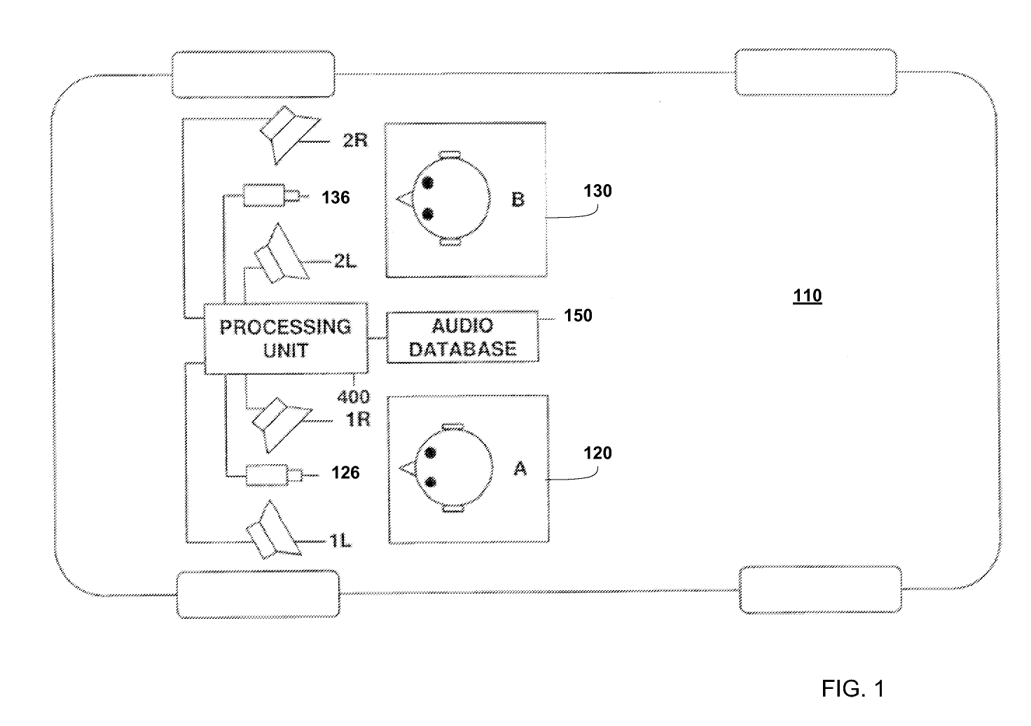

In FIG. 1, a vehicle 110 is schematically shown in which a user-specific sound signal is generated for a first user 120 or user A and a second user 130 or user B. The head position of the first user 120 is tracked using a camera 126, the head position of the second user 130 being tracked using camera 136. The camera may be a simple web cam as known in the art. The cameras 126 and 136 are able to track the heads and are therefore able to determine the exact position of the head. Head tracking mechanisms are known in the art and are commercially available and are not disclosed in detail.

Furthermore, an audio system is provided in which an audio database 150 is schematically shown showing the different audio tracks which should be individually output to the two users. A processing unit 400 is provided that, on the basis of the audio signals provided in the audio database 150, generates a user-specific sound signal. The audio signal in the audio database could be provided in any format, be it a 2.0 stereo signal or a 5.1 or 7.1 or another multi-channel surround sound signal (also elevated virtue loudspeakers 22.2 are possible). The user-specific sound signal for a user A is output using the loudspeakers 1L and 1R, whereas the audio signals for the second user B are output by the loudspeakers 2L and 2R. The processing unit 400 generates a user-specific sound signal for each of the loudspeakers.

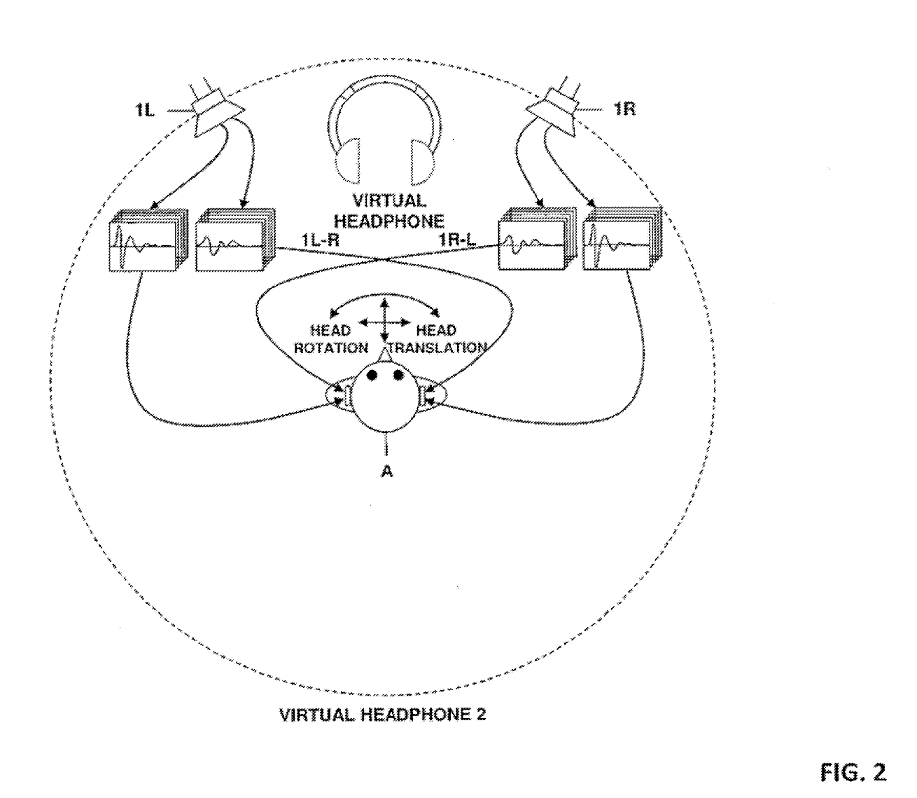

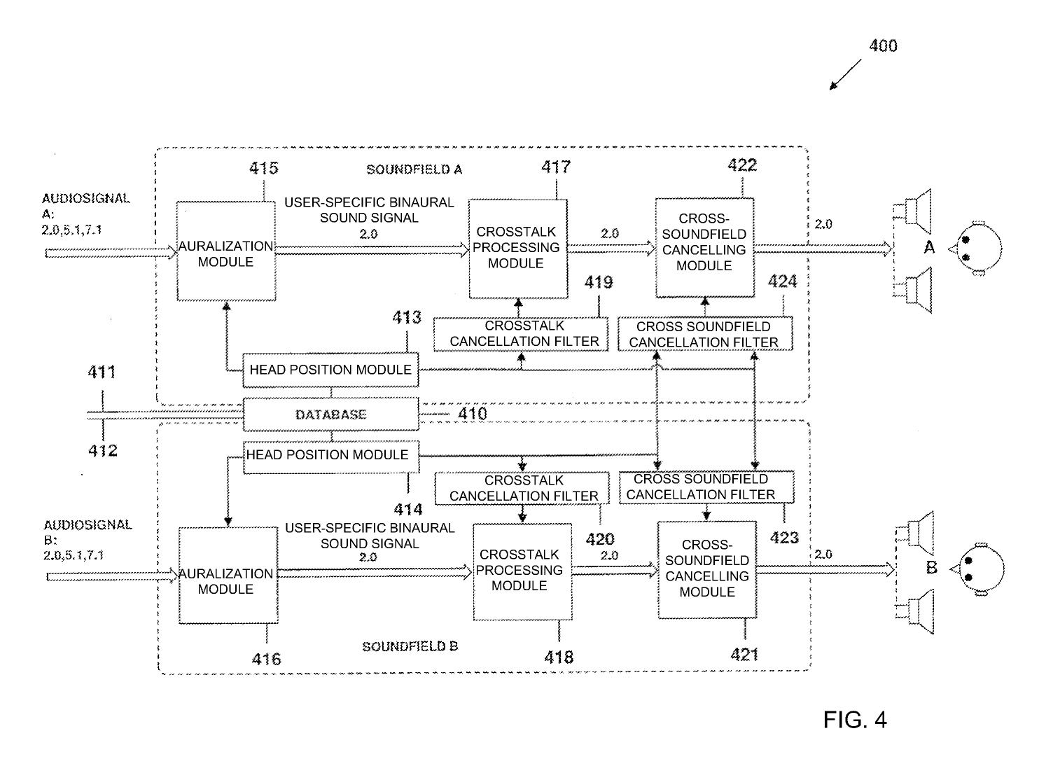

In FIG. 2, a system is shown with which a virtual 3D soundfield using two loudspeakers of the vehicle system can be obtained. With the system of FIG. 2, it is possible to provide a spatial auditory representation of the audio signal, in which a binaural signal emitted by a loudspeaker 1L is brought to the left ear, whereas the binaural signal emitted by loudspeaker 1R is brought to the right ear. To this end a crosstalk cancellation is necessary, in which the audio signal emitted from the loudspeaker 1L should be suppressed for the right ear and the audio output signal of loudspeaker 1R should be suppressed for the left ear. As can be seen from FIG. 2, the received signal will depend on the head position of the user A. To this end the camera 126 (not shown in FIG. 2) tracks the head position by determining the head rotation and the head translation of user A. The camera may determine the three-dimensional translation and the three different possible rotations; however, it is also possible to limit the head tracking to a two-dimensional head translation determination (left and right, forward and backward) and to use one or two degrees of freedom of the possible three head rotations. As will be explained in further detail in connection with FIG. 4, the processing unit 400 contains a database 410 in which binaural room impulse responses for different head translation and rotation positions are stored. These predetermined BRIRs were determined using a dummy head in the same room or a simulation of this room. The BRIRs consider the transition path from the loudspeaker to the ear drum and consider the reflections of the audio signal in the room. The user-specific binaural sound signal for user A from the multi-channel sound signal can be generated by first of all generating the user-specific binaural sound signal and then by performing a crosstalk cancellation in which the signal path 1L-R indicating the signal path from loudspeaker 1L to the right ear and the signal 1R-L for the signal path of loudspeaker 1R to the left ear are suppressed. The user-specific binaural sound signal is obtained by determining a convolution of the multi-channel sound signal with the binaural room impulse response determined for the tracked head position. The crosstalk cancellation will then be obtained by calculating a new filter for the crosstalk cancellation, which depends again on the tracked head position, i.e., a crosstalk cancellation filter. A more detailed analysis of the dynamic crosstalk cancellation in dependence on the head rotation is described in “Performance of Spatial Audio Using Dynamic Cross-Talk Cancellation” by T. Lentz, I. Assenmacher and J. Sokoll in Audio Engineering Society Convention Paper 6541 presented at the 119^{th} Convention, Oct. 2005, 7-10. The crosstalk cancellation is obtained by determining a convolution of the user-specific binaural sound signal with the newly determined crosstalk cancellation filter. After the processing with this new calculated filter, a crosstalk cancelled user-specific sound signal is obtained for each of the loudspeakers which, when output to the user 20, provides a spatial perception of the music signal in which the user has the impression to hear the audio signal not only from the direction determined by the position of the loudspeakers 22 and 23, but from any point in space.

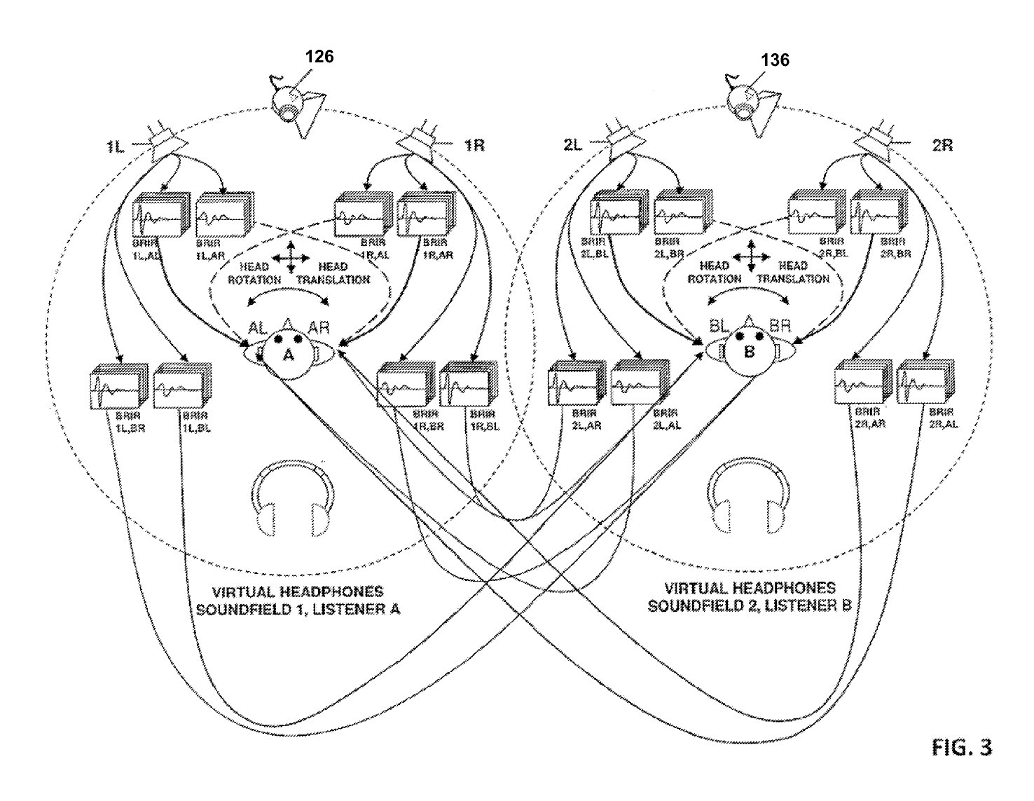

In FIG. 3 the user-specific or individual soundfields for the two users are shown in which, as in the example of FIG. 1, two loudspeakers for the first user A generate the user-specific sound signal for the first user A and two loudspeakers generate the user-specific sound signal for the second user B. The two cameras 126 and 136 are provided to determine the head position of listener A and listener B, respectively. The first loudspeaker 1L outputs an audio signal which would, under normal circumstances, be heard by the left and right ear of listener A, designated as AL and AR. The sound signal 1L, AL, corresponding to the signal emitted from loudspeaker 1L for the left ear of listener A, is shown in bold and should not be suppressed. The other sound signal 1L, AR for the right ear of listener A should be suppressed (shown in a dashed line). In the same way, as already discussed in connection with FIG. 2, the signal 1R, AR should arrive at the right ear and is shown in bold, whereas the signal 1R, AL for the left ear should be suppressed (shown in a dashed line). Additionally, however, the signals from the loudspeakers 1L and 1R are normally perceived by listener B. In a cross-soundfield cancellation these signals have to be suppressed. This is symbolized by the signals 1L, BR; 1L, BL corresponding to the signals emitted form loudspeaker 1L and perceived by the left and right ear of listener B. In the same way the signals emitted by loudspeaker 1R should not be perceived by the left and right ear of listener B, as is symbolized by 1R, BR and 1R, BL.

In the same way the signals emitted by the loudspeakers 2L and 2R should be suppressed for listener A as symbolized by the signal path 2L, AR, the path 2L, AL, the signal path 2R, AR, and the signal path 2R, AL. For the crosstalk cancellation and for the cross-soundfield cancellation the binaural room impulse response for the detected head position has to be determined, as this BRIR of listener A and BRIR of listener B are used for the auralization, the crosstalk cancellation and the cross-soundfield cancellation.

In FIG. 4, a more detailed view of the processing unit 400 is shown, with which the signal calculation, as symbolized in FIG. 3, can be carried out. For each of the listeners the processing unit receives an audio signal for the first user, listener A, described as audio signal A, and an audio signal B for the second user, listener B. As already discussed above, the audio signal is a multi-channel audio signal of any format. In FIG. 4, the different calculation steps are symbolized by different modules for facilitating the understanding of the invention. However, it should be understood that the processing may be performed by a single processing unit carrying out the different calculation modules symbolized in FIG. 4. The processing unit contains a database 410 containing the set of different binaural room impulse responses for the different head positions for the two users. The processing unit receives the head positions of the two users as symbolized by inputs 411 and 412. Depending on the head position of each user, the corresponding BRIR for the head position can be determined for each user. The head position itself is symbolized by module 413 and 414 and is fed to the different modules for further processing. In the first processing module, the multi-channel audio signal is converted into a binaural audio signal that, if it was output by a headphone, would give the 3D impression to the listening person. This user-specific binaural sound signal is obtained by determining a convolution of the multi-channel audio signal with the corresponding BRIR of the tracked head position. This is done for listener A and listener B, as symbolized by the modules 415 and 416, where the auralization is carried out. The user-specific binaural sound signal is then further processed as symbolized by modules 417 and 418. Based on the binaural room impulse response a crosstalk cancellation filter is calculated in units 419 and 420, respectively for user A and user B. The crosstalk cancellation filter is then used for determining the crosstalk cancellation by determining a convolution of the user-specific binaural sound signal with the crosstalk cancellation filter. The output of modules 417 and 418 is a crosstalk cancelled user-specific sound signal, that, if output in a system as shown in FIG. 2, would give the listener the same impression as the listener listening to the user-specific binaural sound signal using a headphone. In the next modules 421 and 422 the cross-soundfield cancellation is carried out, in which the soundfield of the other user is suppressed. As the soundfield of the other user depends on the head position of the other user, the head positions of both users are necessary for the determination of a cross-soundfield cancellation filter in units 423 and 424, respectively. The cross-soundfield cancellation filter is then used in units 421 and 422 to determine the cross-soundfield cancellation by determining a convolution of the crosstalk cancelled users-specific sound signal emitted from 417 or 418 with the filter determined by modules 424 and 423, respectively. The filtered audio signal is then output as a user-specific sound signal to user A and user B.

As shown in FIG. 4, three convolutions are carried out in the signal path. The filtering for auralization, crosstalk cancellation and cross-soundfield cancellation can be carried out one after the other. In another example, three different filtering operations may be combined to one convolution using one filter which was determined in advance. A more detailed discussion of the different steps carried out in the dynamic crosstalk cancellation can be found in the papers of T. Lentz discussed above. The dynamic cross-soundfield cancellation works in the same way as dynamic crosstalk cancellation, in which not only the signals emitted by the other loudspeaker have to be suppressed, but also the signals from the loudspeakers of the other user.

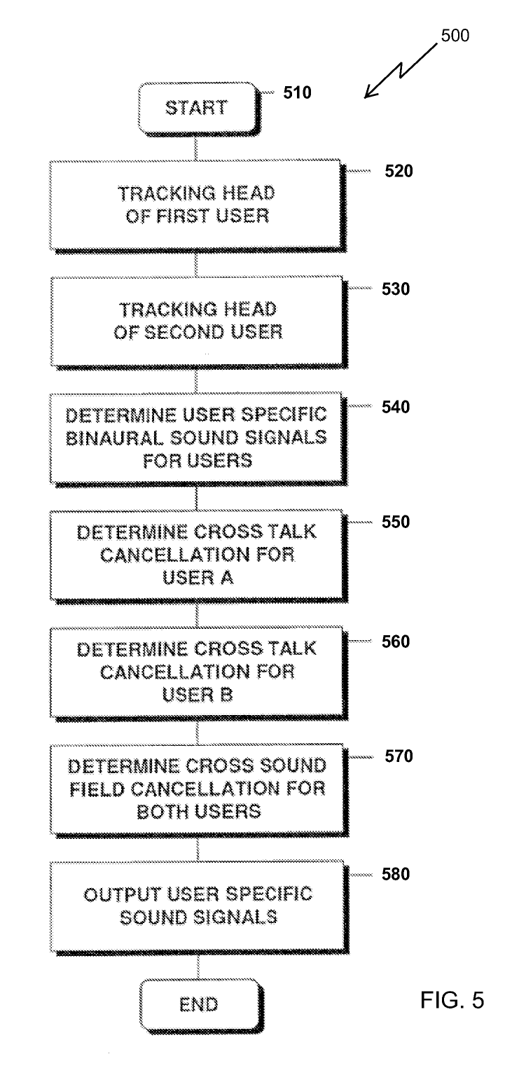

In FIG. 5, the different steps 500 for the determination of the user-specific soundfield are summarized. After the start of the method in step 510, the head of user A and user B are tracked in steps 520 and 530. Based on the head position of user A, a user-specific binaural sound signal is determined for user A, and based on the tracked head position of user B the user-specific binaural sound signal is determined for user B (step 540). In the next steps 550 and 560, the crosstalk cancellation for user A and for user B is determined. In step 570 the cross-soundfield cancellation is determined for both users. The result after step 570 is a user-specific sound signal, meaning that a first channel was calculated for the first loudspeaker of user A and a second channel was calculated for the second loudspeaker of user A. In the same way, a first channel was calculated for the first loudspeaker of user B and a second channel was calculated for the second loudspeaker of user B. When the signals are output after step 580, an individual soundfield for each user is obtained. As a consequence, each user can chose his or her individual sound material. Additionally, individual sound settings can be chosen and an individual sound pressure level can be selected for each user. The system described above was described for a user-specific sound signal for two users. However, it is also possible to provide a user-specific sound signal for three or more users. In such an example, in the cross-soundfield cancellation the soundfields provided by the other users have to be suppressed and not only the soundfield of one other user, as in the examples described above. However, the principle remains the same.

It will be understood, and is appreciated by persons skilled in the art, that one or more processes, sub-processes, or process steps described in connection with FIGS. 1-5 may be performed by hardware and/or software. If the process is performed by software, the software may reside in software memory (not shown) in a suitable electronic processing component or system such as, one or more of the functional components or modules schematically depicted in FIGS. 1-5. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for providing a user-specific sound signal for a first user of at least two users of a sound system in a room, the sound system including at least one pair of loudspeakers for each of the at least two users, the method comprising the steps of:
tracking the head position of the first user;
generating a user-specific binaural sound signal for the first user from a user-specific multi-channel sound signal for the first user based on the tracked head position of the first user;
performing a crosstalk cancellation for the first user based on the tracked head position of the first user for generating a crosstalk cancelled user-specific sound signal, in which the user-specific binaural sound signal is processed in such a way that the crosstalk cancelled user-specific sound signal, if it was output by one loudspeaker of the pair of loudspeakers of the first user for a first ear of the first user, is suppressed for the second ear of the first user and that the crosstalk cancelled user specific sound signal, if it was output by the other loudspeaker of the pair of loudspeakers for a second ear of the first user, is suppressed for the first ear of the first user; and
performing a cross-soundfield suppression in which the sound signals output for the second user by the pair of loudspeakers provided for the second user are suppressed for each ear of the first user based on the tracked head position of the first user.

2. The method of claim 1, where the user-specific binaural sound signal for the first user is generated based on a set of predetermined binaural room impulse responses determined for the first user for a set of possible different head positions of the first user in the room that were determined in the room with a dummy head, where the user-specific binaural sound signal of the first user is generated by filtering the multi-channel user-specific sound signal with the binaural room impulse response of the tracked head position.

3. The method of claim 1, where the head position is tracked by determining a translation of the head in three dimensions and by determining a rotation of the head along three possible rotation axes of the head, where the set of predetermined binaural room impulse responses contains binaural room impulse responses for the possible translation and rotations of the head.

4. The method of claim 2, where the user-specific binaural sound signal of the first user at the head position is determined by determining a convolution of the user-specific multi-channel sound signal for the first user with the binaural room impulse response determined for the head position.

5. The method of claim 1, where for the crosstalk cancellation for the first user a head position dependent filter is determined using the tracked position of the head and using the binaural room impulse response for the tracked position of the head position, where the crosstalk cancellation is determined by determining a convolution of the user-specific binaural sound signal with the head position dependent filter.

6. The method of claim 1, where the sound signal of the second user is also a user-specific sound signal for which the head position of the second user is tracked, where a user-specific binaural sound signal for the second user is generated based on a user-specific multi-channel sound signal for the second user and based on the tracked head position of the second user, where a crosstalk cancellation for the second user is carried out based on the tracked head position of the second user and a cross-soundfield suppression in which the sound signals emitted for the first user by the pair of loudspeakers of the first user are suppressed for each ear of the second user based on the tracked head position of the second user.

7. The method of claim 6, where the user-specific binaural sound signal for the second user is generated based on a set of predetermined binaural room impulse responses determined for the second user for a set of possible different head positions of the second user in the room with a dummy head and based on the tracked head position, where the binaural room impulse response of the tracked head position is used to determine the user-specific binaural sound signal of the second user at the head position.

8. The method of claim 6, where the cross-soundfield suppression of the sound signals output for one of the users and suppressed for other of the users is determined based on the tracked head position of the first user and on the tracked head position of the second user and based on the binaural room impulse response for the first user at the tracked head position of the first user and based on the on the binaural room impulse response for the second user at the tracked head position of the second user.

9. The method of claim 1, where the room is a vehicle cabin, where the user-specific sound signal is a vehicle seat position related soundfield, the pair of loudspeakers being fixedly installed vehicle loudspeakers.

10. A system for providing a user specific sound signal for a first user of at least two users in a room, the system comprising:
a pair of loudspeakers for each of the at least two users for outputting respective sound signals for each of the at least two users;
a camera for tracking the head position of the first user;
a database containing a set of predetermined binaural room impulse responses determined for the first user for different possible different head positions of the first user in the room;
a processing unit configured to process a user-specific multi-channel sound signal in order to determine a user-specific binaural sound signal for the first user based on the user-specific multi-channel sound signal for the first user and based on the tracked head position of the first user provided by the camera, and configured to perform a crosstalk cancellation for the first user based on the tracked head position of the first user for generating a crosstalk cancelled user-specific sound signal, in which the user-specific binaural sound signal is processed in such a way that the crosstalk cancelled user-specific sound signal, if it was output by one loudspeaker of the pair of loudspeakers of the first user for a first ear of the first user, is suppressed for the second ear of the first user and that the crosstalk cancelled user-specific sound signal, if it was output by the other loudspeaker of the pair of loudspeakers for a second ear of the first user, is suppressed for the first ear of the first user;
and configured to perform a cross-soundfield suppression in which the sound signals emitted for the second user by loudspeakers for the second user are suppressed for each ear of the first user based on the tracked head position of the first user.

11. The system of claim 10, where the database further contains a set of predetermined binaural room impulse responses determined for the second user for different possible head positions of the second user in the room.

12. The system of claim 11, further comprising a second camera tracking the head position of the second user, where the processing unit performs a cross-soundfield suppression based on the tracked head position of the first user and on the tracked head position of the second user and based on the binaural room impulse response for the first user and the tracked head position of the first user and based on the on the binaural room impulse response for the second user and the tracked head position of the second user.

13. The system of claim 10, where the camera is configured to track the first user's head position in three dimensions.

14. The system of claim 10, wherein the binaural sound signal of the first user is determined by determining a convolution of the user-specific multi-channel sound signal for the first user with the binaural room impulse response determined for the head position.

15. The system of claim 10, wherein the processing unit is further configured to process a user-specific multi-channel sound signal in order to determine a user-specific binaural sound signal for a second of the at least two users, based on the user-specific multi-channel sound signal for the second user and based on the tracked head position of the second user provided by the camera, and configured to perform a crosstalk cancellation for the second user based on the tracked head position of the second user for generating a crosstalk cancelled user-specific sound signal, in which the user-specific binaural sound signal is processed in such a way that the crosstalk cancelled user-specific sound signal, if it was output by one loudspeaker of the pair of loudspeakers of the second user for a first ear of the second user, is suppressed for the second ear of the second user and that the crosstalk cancelled user-specific sound signal, if it was output by the other loudspeaker of the pair of loudspeakers for a second ear of the second user, is suppressed for the first ear of the second user.

16. The system of claim 15, where the user-specific binaural sound signal for the second user is generated based on a set of predetermined binaural room impulse responses determined for the second user for a set of possible different head positions of the second user in the room with a dummy head and based on the tracked head position, where the binaural room impulse response of the tracked head position is used to determine the user-specific binaural sound signal of the second user at the head position.
